(19) United States
(12) Patent Application Publication
(10) Pub. No.: US 2025/0355124 A1
(43) Pub. Date: Nov. 20, 2025

(54) COMPENSATING FOR RADIATION DAMAGE IN SEMICONDUCTOR-BASED RADIATION DETECTORS

(71) Applicant: KROMEK LIMITED, Sedgefield (GB)

(72) Inventor: Edward Marsden, Sheffield (GB)

(21) Appl. No.: 19/210,594

(22) Filed: May 16, 2025

(30) Foreign Application Priority Data
May 17, 2024 (GB) 2407073.2

(51) Int. Cl. G01T 1/24; G01T 1/02

(52) U.S. Cl. CPC G01T 1/244; G01T 1/026

(57) ABSTRACT

A method of compensating for high energy radiation damage to a semiconductor, in a semiconductor-based radiation detector, the method including: (a) detecting, using the detector, a radiation signal, wherein the detector comprises the semiconductor; (b) detecting, using a temperature sensor, a temperature of the detector; (c) detecting a leakage current in the detector; (d) determining a compensated leakage current based on the detected temperature; (e) determining a high energy radiation exposure based on the compensated leakage current; (f) determining, using the detected radiation signal, a compensated radiation signal based on the determined high energy radiation exposure; and (g) outputting the compensated radiation signal.

### CROSS REFERENCE TO RELATED APPLICATION

This application claims priority to Great Britain Patent Application Serial No. 2407073.2, filed on May 17, 2024, and entitled “COMPENSATING FOR RADIATION DAMAGE IN SEMICONDUCTOR-BASED RADIATION DETECTORS,” the contents of which are incorporated by reference herein.

### FIELD

The present invention relates to a method for and a semiconductor-based radiation detector configured to compensate for high energy radiation damage to the semiconductor. In particular, the radiation detector is a dose rate measurement device for the measurement of a radiation dose in a high radiation environment. In a preferred embodiment, the high energy radiation damage is caused by fast neutron radiation.

### BACKGROUND

Radiation detectors find various applications in radiation level measurement devices such as dose meters for the measurement of an immediate radiation level or cumulative radiation level or dose in a high radiation environment. Radiation of concern in such an environment may include high energy electromagnetic radiation, such as x-rays and/or gamma rays and subatomic particle radiation. The invention in particular concerns, but is not limited to, gamma radiation dose rate measurement devices for application in potentially higher radiation environments.

Traditional devices, particular for higher dose rate environments, that is, environments with higher levels of gamma radiation, have made extensive use of Geiger Muller (G-M) tubes. G-M tubes are robust and effective, and have a long record of successful use in radiation dose meters, but the technology is old and bulky, and response times may be slow relative to solid state alternatives. At lower dose rates, scintillator detectors have found application in radiation dose meters. There is a desire to develop solid state solutions that are effective at higher rates, and this has led to the development of semiconductor-based radiation detection devices based on photodiode arrays. It is also known to provide radiation dose meters having one or more lower dose rate sensors based on scintillator detectors and one or more higher dose rate sensors based on photodiode arrays.

Semiconductor-based radiation detection devices based on photodiode arrays offer a number of advantages over more conventional radiation detection devices, such as Geiger Muller tubes. For example, semiconductor-based detectors are typically smaller in size and tend to have faster response times, making them particularly suitable for radiation dosimetry applications.

Semiconductor-based radiation detectors are known to incur damage when exposed to particularly high energy radiation, such as from fast neutrons. These fast neutrons can damage the semiconductor crystal by causing displacements of atoms in the semiconductor's crystalline structure. This damage can occur instantaneously in the event of a particularly large radiation event, for example a nuclear explosion. The damage may also occur incrementally when a semiconductor-based detector is exposed to fast neutrons over a period of time, for example over a course of months or years when the detectors are being used in nuclear power plants near nuclear reactors, or when being used in the process of nuclear decommissioning. Both the instantaneous and the incremental damage to the semiconductor can cause the detector to become less sensitive with time or less accurate with time.

A known method for compensating for this radiation damage is to expose the semiconductor to temperature extremes, such as a high temperature followed by a lower temperature at a relatively high rate of change. This process is known as temperature cycling. Temperature cycling can reverse at least some of the damage done to the semiconductor crystal. However, this is clearly time and resource intensive and alternative methods to compensate for the damage to the semiconductor crystals are sought (i.e. in-situ compensation).

The present invention seeks to overcome at least some of these disadvantages.

### BRIEF SUMMARY

According to a first aspect of the invention, there is provided a method of compensating for high energy radiation damage to a semiconductor, in a semiconductor-based radiation detector, the method comprising: (a) detecting, using the detector, a radiation signal, wherein the detector comprises the semiconductor; (b) detecting, using a temperature sensor, a temperature of the detector; (c) detecting a leakage current in the detector; (d) determining a compensated leakage current based on the detected temperature; (e) determining a high energy radiation exposure based on the compensated leakage current; (f) determining, using the detected radiation signal, a compensated radiation signal based on the determined high energy radiation exposure; and (g) outputting the compensated radiation signal. Advantageously, this method has the effect of compensating for damage to the semiconductor of the semiconductor-based detector which results from high energy radiation damage (e.g. as a result of fast neutron damage). This advantageously allows a radiation detector to compensate for damage without undergoing a temperature cycling process, enabling in-situ compensation.

In an embodiment, the detector comprises an array of separately addressable detector elements, and for example a two-dimensional array of separately addressable detector elements. The detector elements may be physically discrete. The array of detector elements may comprise a photodiode array.

In such an embodiment, the method comprises: (a) detecting, using a photodiode of the detector, a radiation signal, wherein the photodiode comprises the semiconductor; (b) detecting, using a temperature sensor, a temperature of the photodiode; (c) detecting a leakage current in the photodiode; (d) determining a compensated leakage current based on the detected temperature; (e) determining a high energy radiation exposure based on the compensated leakage current; (f) determining, using the detected radiation signal, a compensated radiation signal based on the determined high energy radiation exposure; and (g) outputting the compensated radiation signal.

In an embodiment, the detector is one of a radiation dose rate detector, a radioisotope identification device, a radiation imaging device or other radiological detection device.

In an embodiment, the radiation detected by the semiconductor-based radiation detector comprises at least one selected from the following list: X-ray radiation, Gamma radiation, neutron radiation, alpha radiation and beta radiation.

In an embodiment, the measured semiconductor leakage current L is adjusted to compensate for effects of temperature T. The compensated leakage current L′=L+AT³+BT²+CT+D1. The constants of the multi-term polynomial A, B, C and D are determined by characterising the leakage current of the semiconductor against temperature.

In an embodiment, the compensated radiation signal, D′, is determined based on a function of the detected radiation signal, D, the high energy radiation exposure, and a constant determined by experimental measurements.

In an embodiment, the high energy radiation which causes damage comprises fast neutrons. Advantageously, this allows the method to compensate for damage to the semiconductor which may occur in the event of a nuclear explosion, during nuclear decommissioning, or when monitoring a nuclear reactor.

In an embodiment, determining a fast neutron exposure, N, based on the compensated leakage current, L′, comprises: N=L′/X. Where X is a scaling factor determined by experimentation.

In an embodiment, the adjusted dose rate D′ is calculated from the measured dose rate D and neutron exposure N (i.e. when the high energy radiation exposure is a neutron exposure), whereby D′=DNZ, where Z is a constant determined by experimental measurements.

Suitable materials for the semiconductor detector, and in the preferred embodiment for the photodiode array, comprises Silicon. The semiconductor materials may further comprise Germanium or cadmium telluride, cadmium zinc telluride (CZT), cadmium manganese telluride (CMT), and alloys thereof. The semiconductor material may be comprised of any suitable semiconductor materials for detecting a radiation signal via a direct response detector.

According to a second aspect of the invention, there is provided a radiation detector system comprising: a semiconductor-based radiation detector; a compensation module configured to perform the steps of the first aspect of the invention in response to and to compensate for high energy radiation damage to the semiconductor material of the semiconductor-based radiation detector.

Advantageously, this provides a device capable of detecting high energy radiation and which is configured to compensate for damage to the semiconductor component in the event of a high radiation event (e.g. in the event of a nuclear explosion when there is emitted a large flux of fast neutrons).

The compensation module may be provided by a processor and a set of instructions that, when executed by the processor, cause the processor and/or further control elements of the compensation module to perform the steps of the method of the first aspect of the invention.

In an embodiment, the detector system is a radiation dose meter. For example, the radiation dose meter is a gamma dose meter. That is, typically, the semiconductor-based radiation detector is selected configured to be sensitive to electromagnetic radiation in the gamma ray spectrum/to electromagnetic radiation with a frequency greater than or equal to 3×10¹⁹ Hz. In an alternative embodiment, the detector system comprises one of a radioisotope identification device, a radiation imaging device or other radiological detection device.

In a more complete embodiment, the radiation dose meter has at least one first detector module optimised to measure a dose at a first, lower dose rate and at least one second detector module optimised to measure a dose at a second, higher dose rate. Optionally in such a case the first detector module and/or the second detector module may comprise a semiconductor-based radiation detector compensated as hereinabove.

In an embodiment, the detector further comprises a third radiation detector module, the third radiation detector optimised to measure a dose at a third rate, wherein the third rate is greater than the first and second rate.

### BRIEF DESCRIPTION OF THE SEVERAL VIEWS OF THE DRAWINGS

Embodiments of the present invention will now be described by way of example only and with reference to the accompanying drawings, in which:

FIG. 1 depicts a flow-diagram of the method in accordance with a first aspect of the present invention;

FIG. 2 depicts an empirically derived relationship between the detected leakage current as a function of the temperature of the photodiode in a semiconductor-based detector;

FIG. 3 depicts an empirically derived relationship between the leakage current which has been compensated for its temperature dependence and the neutron exposure;

FIG. 4 depicts a schematic of a semiconductor-based radiation detector configured to compensate for high energy radiation damage to the semiconductor, in accordance with the second aspect of the invention.

### DETAILED DESCRIPTION

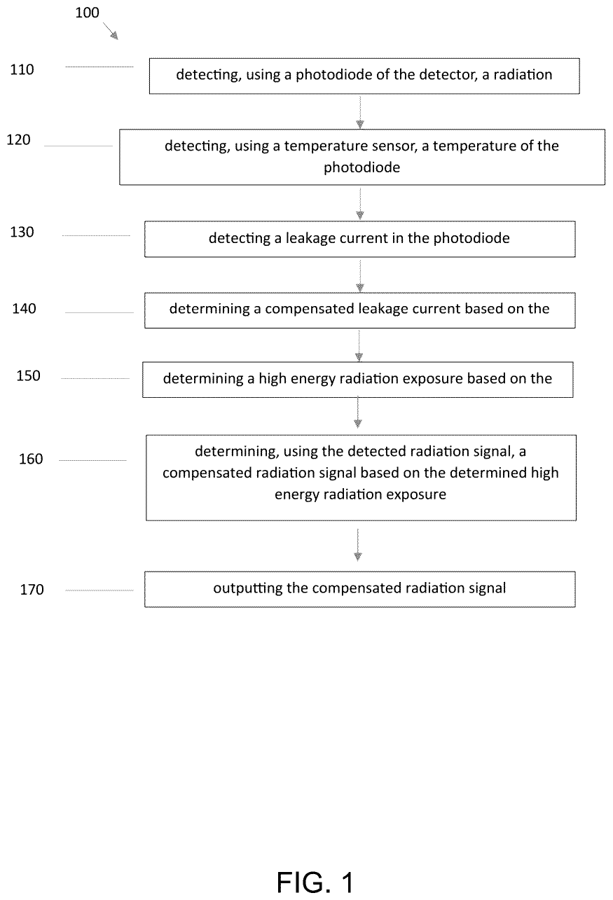

With reference to FIG. 1, this depicts a method 100 of compensating for high energy radiation damage to a semiconductor, in a semiconductor-based radiation detector. The method 100 comprises steps 110 to 170. Step 110 comprises detecting, using a photodiode of the detector, a radiation signal. The photodiode comprises the semiconductor. Step 120 comprises detecting, using a temperature sensor, a temperature of the photodiode. Step 130 comprises detecting a leakage current in the photodiode. Step 140 comprises determining a compensated leakage current based on the detected temperature. Step 150 comprises determining a high energy radiation exposure based on the compensated leakage current. Step 160 comprises determining, using the detected radiation signal, a compensated radiation signal based on the determined high energy radiation exposure. Step 170 comprises outputting the compensated radiation signal.

In use, the high energy radiation which may damage the semiconductor of the semiconductor detector may be fast neutrons (also called fast neutron radiation herein). Fast neutrons may be regarded as any neutron with an energy capable of damaging the semiconductor of the detector (for example, by creating defects in the crystalline lattice). Fast neutrons may be any neutron radiation with an energy greater than or equal to 1 MeV. In an alternative embodiment, any form of radiation which is capable of damaging the semiconductor may be considered a high energy radiation.

In an embodiment, the semiconductor may comprise a material selected from one of Silicon, Germanium or cadmium telluride, cadmium zinc telluride (CZT), cadmium manganese telluride (CMT), and alloys thereof.

In an embodiment, the radiation detected by the semiconductor-based radiation detector comprises electromagnetic radiation with a frequency greater than or equal to 3×10¹⁹ Hz (i.e. gamma radiation). In an alternative embodiment, the radiation may be other forms of radiation detectable by the particular semiconductor used by the photodiode of the detector. For example, in an alternative embodiment, the radiation may be alpha radiation, beta radiation, or other forms of electromagnetic radiation (e.g. hard X-rays etc.).

In an embodiment, the temperature may be detected by a temperature sensor, such as a thermocouple, a thermistor, a discrete semiconductor-based integrated circuit, IC, temperature sensor, or any other suitable temperature sensor.

In an embodiment, the leakage current may be detected by an analogue to digital convertor, ADC.

In an embodiment, determining a compensated leakage current based on the detected temperature (Step 140 of FIG. 1) may comprise determining using a functional relationship between the temperature and the leakage current. In a further embodiment, step 140 may comprise using a functional relationship which has been established empirically based on previous tests of how the leakage current responds to changing temperature, in a functional manner. In an even further embodiment, step 140 may be determined using Equation 1:

L′=L+AT³+BT²+CT+D; Equation 1:

Wherein (L′) is the compensated leakage current (nA), (L) is the measured leakage current and (T) is the temperature of the photodiode as detected by the temperature sensor (° C.). Equation 1 may be determined by determining an empirical relationship between the temperature and the leakage current. A, B, C and D are constants determined by characterising the leakage current L, of the semiconductor against temperature, T.

In an embodiment, determining a high energy radiation exposure based on the compensated leakage current (step 150 of FIG. 1) may comprise determining using a functional relationship between high energy radiation exposure (e.g. fast neutron exposure) and the compensated leakage current (i.e. the outcome of step 140). In a further embodiment, step 150 may comprise using a functional relationship which has been established empirically based on previous tests of how the compensated leakage current responds to the high energy radiation exposure, in a functional manner. In an even further embodiment, when the high energy radiation is fast neutron radiation (or simply neutron radiation), step 150 may be determined using Equation 2:

N=L′/X; Equation 2:

Wherein (L′) is the compensated leakage current (as determined in step 140), (N) is the fast neutron exposure (cGy), and (X) is a scaling factor determined by experimentation. Equation 2 may be determined by determining an empirical relationship between the compensated leakage current and the fast neutron exposure.

In an embodiment, determining, using the detected radiation signal, a compensated radiation signal based on the determined high energy radiation exposure (step 160 of FIG. 1) may comprise determining using a functional relationship between high energy radiation exposure (e.g. fast neutron exposure) and the compensated radiation signal. In a further embodiment, step 160 may comprise using a functional relationship which has been established empirically based on previous tests of how the high energy radiation exposure responds to the compensated radiation signal, in a functional manner. In a further embodiment, the compensated radiation signal, D′, is determined based on a function of the detected radiation signal, D, the high energy radiation exposure, and a constant determined by experimental measurements. In an even further embodiment, when the high energy radiation is fast neutron radiation (or simply neutron radiation), step 160 may be determined using Equation 3:

D′=DNZ Equation 3:

Wherein Z comprises a constant determined by experimental measurements.

In an embodiment, step 170 of FIG. 1 may comprise outputting the compensated radiation signal using a display device.

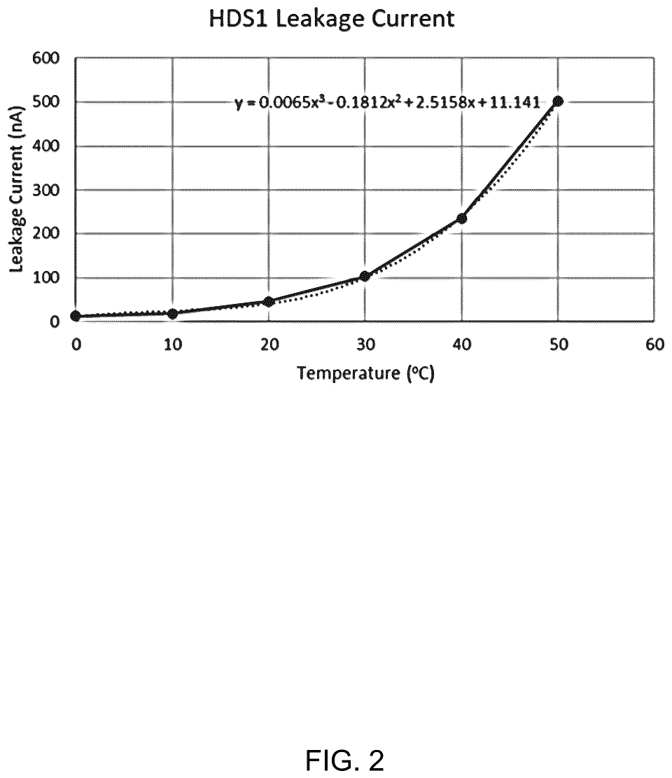

With reference to FIG. 2, this depicts an empirically measured functional relationship between the detected leakage current (nA) and the temperature of the photodiode (° C.). FIG. 2 depicts a line of best fit of the graphed data, showing that the functional relationship is that expressed in Equation 1 (shown above).

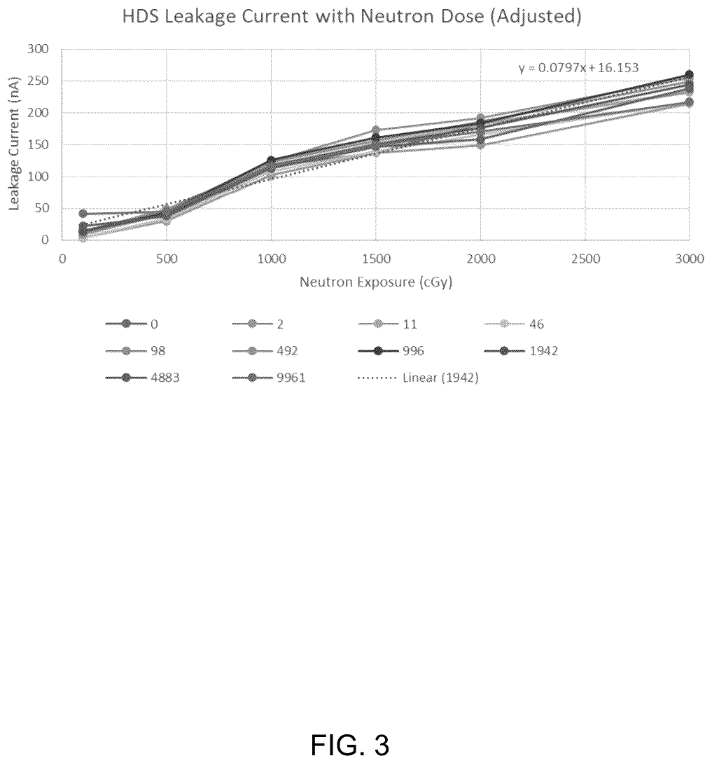

With reference to FIG. 3, this depicts an empirically measured functional relationship between the compensated leakage current (nA) and the neutron exposure (cGy). FIG. 3 depicts a line of best fit of the graphed data, showing that the functional relationship is that expressed in Equation 2 (shown above).

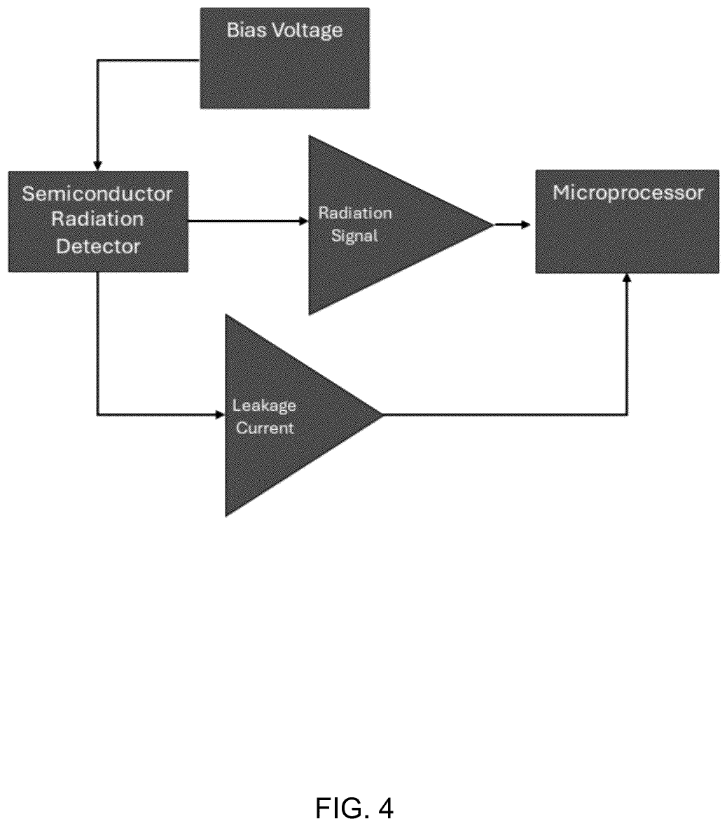

With reference to FIG. 4, this depicts a semiconductor-based radiation detector configured to compensate for high energy radiation damage to the semiconductor. There is depicted a semiconductor radiation detector module. There is depicted a means for applying a bias voltage to the semiconductor radiation detector module. The semiconductor radiation detector is configured to output a measured radiation signal, and a measured leakage current, to a microprocessor.

It will be appreciated that the above-described embodiments of the first and second aspects of the present invention are given by way of example only, and that various modifications may be made to the embodiments without departing from the scope of the invention as defined in the appended claims.

What is claimed is:

1. A method of compensating for high energy radiation damage to a semiconductor, in a semiconductor-based radiation detector, the method comprising:
a) detecting, using a detector, a radiation signal, wherein the detector comprises the semiconductor;
b) detecting, using a temperature sensor, a temperature of the detector;
c) detecting a leakage current, L, in the detector;
d) determining a compensated leakage, L′, current based on the detected temperature;
e) determining a high energy radiation exposure based on the compensated leakage current, L′;
f) determining, using the detected radiation signal, a compensated radiation signal based on the determined high energy radiation exposure; and
g) outputting the compensated radiation signal.

2. The method of claim 1, wherein the detector is a radiation dose rate detector selected from the group consisting of: a radioisotope identification device, a radiation imaging device, and another radiological detection device.

3. The method of claim 1, wherein the radiation detected by the semiconductor-based radiation detector comprises at least one selected from the group consisting of: X-ray radiation, Gamma radiation, neutron radiation, alpha radiation, and beta radiation.

4. The method of claim 1, wherein determining the compensated leakage current, L′, based on the measured leakage current, L, and the temperature, T, comprises:
L′=L+AT3+BT2+CT+D;
wherein A, B, C and D are constants determined by characterising the leakage current L, of the semiconductor against temperature, T.

5. The method of claim 1, wherein the compensated radiation signal, D′, is determined based on a function of the detected radiation signal, D, the high energy radiation exposure, and a constant determined by experimental measurements.

6. The method of claim 1, wherein the high energy radiation which causes damage comprises fast neutrons.

7. The method of claim 6, wherein determining a fast neutron exposure, N, based on the compensated leakage current, L′, comprises:
N=L′/X;
wherein X comprises a scaling factor determined by experimentation.

8. The method of claim 7, wherein determining the compensated radiation signal, D′, comprises:
D′=DNZ;
wherein D comprises the detected radiation signal and Z comprises a constant determined by experimental measurements.

9. A semiconductor-based radiation detector system comprising:
a semiconductor-based radiation detector;
a compensation module configured to perform the steps of any preceding claim in response to and to compensate for high energy radiation damage to the semiconductor material of the semiconductor-based radiation detector.

10. The detector system of claim 9, wherein the compensation module comprises a processor and a set of instructions that, when executed by the processor, cause the processor and further control elements of the compensation module to perform the steps.

11. The detector system of claim 9, wherein the system is selected from the group consisting of: a radiation dose meter, a radioisotope identification device, a radiation imaging device, and other radiological detection device.

12. The detector system of claim 11, wherein the radiation dose meter has at least one first radiation detector module optimised to measure a dose at a first, lower dose rate and at least one second radiation detector module optimised to measure a dose at a second, higher dose rate, at least the second radiation detector module comprising the semiconductor-based radiation detector and the compensation module.

13. The detector system of claim 10, wherein the first radiation detector module and the second radiation detector comprises a photodiode array.
